(19) United States
(12) Patent Application Publication
(10) Pub. No.: US 2009/0292587 A1
(43) Pub. Date: Nov. 26, 2009

(54) CROSS-MEDIA INTERACTIVITY METRICS

(75) Inventor: Joan G. FITZGERALD, Arlington, VA (US)

Correspondence Address: KATTEN MUCHIN ROSENMAN LLP / ARBITRON INC.;(C/O PATENT ADMINISTRATOR), 2900 K STREET NW, SUITE 200, WASHINGTON, DC, 20007-5118, US

(73) Assignee: Arbitron, Inc., Columbia, MD (US)

(21) Appl. No.: 12/425,127

(22) Filed: Apr. 16, 2009

Related U.S. Application Data
(60) Provisional application No. 61/045,827, filed on Apr. 17, 2008.

(51) Int. Cl. G06Q 10/00; G06Q 30/00

(52) U.S. Cl. 705/10

(57) ABSTRACT

Processes and systems for use in media and market research are provided. In certain embodiments, media usage activities relating to interactivity between two or more media are measured and correlated to produce a metric for rating the interactivity.

### CROSS-REFERENCE TO RELATED APPLICATIONS

This application claims the benefit of U.S. Provisional Patent Application No. 61/045,827, entitled “Cross-Media Interactivity Metrics”, filed Apr. 17, 2008, the entire contents of which are expressly incorporated herein by reference.

### FIELD OF TECHNOLOGY

The present invention relates to systems and processes for use in media and/or market research, and more particularly to methods and systems relating to audience measurement metrics having applicability across a variety of media types.

### BACKGROUND OF THE INVENTION

Consumers are exposed to a wide variety of media, including television, radio, print, outdoor advertisements (e.g., billboards) and other forms. Numerous surveys and, more recently, electronic devices are utilized to ascertain the types of media to which individuals and households are exposed. The results of such surveys and data acquired by electronic devices (e.g., ratings data) are currently utilized to set advertising rates and to guide advertisers as to where and when to advertise.

Radio and television audience estimates, as well as estimates of audiences for other media, provide a useful tool in assessing the value of advertising through such media. But they do not directly measure the effectiveness of the advertisements in influencing consumers to purchase the advertised product or service. In an attempt to overcome this problem, numerous different datasets pertaining to media exposure of consumers and the shopping and purchasing habits of consumers have been made available.

The various types of media and market research information identified above, as well as others not mentioned, are produced by different companies and usually are presented in different formats, concerning different time periods, different products, different media, etc. It is therefore desired to reconcile the data from multiple sources and/or representing different information in an accurate and meaningful way to derive information that is both understandable and useful.

In addition to the foregoing, various electronic devices (e.g., bar code scanners) are employed to track, among other things, consumer purchasing behavior, but such devices usually track activity only at the household level. Prior attempts to convert data at the household level to data at the person level have resulted in substantial inaccuracies. In one previously utilized conversion process, it is assumed that the household behavior or activity was carried out by each and every household member. Thus, if the data identifies that a household purchased a particular product, then such data is converted into data indicative that each person in the household had purchased the product. A second previously utilized conversion process assumes that only a single person with certain characteristics (i.e., female head of household) in the household had performed all of the reported behavior or activity. Thus, if a dataset includes data that indicates that a household purchased, for example, fifty identified items (e.g., data obtained from a barcode scanner panel), then that data is converted to data that indicates that only a single person had purchased every one of those fifty items. When a household does not include a person with the above-mentioned characteristics, then no person in the household is deemed to have made the purchases. In the case of tracking Internet usage, the process deems that all of the Internet usage was carried out by only a single person in the household.

The first process for converting household level data to person level data identified above overstates behaviors for households with multiple members. The second process sometimes understates behaviors, but more importantly introduces inaccuracies in the conversion since household behavior is generally carried out by multiple individuals, especially in large households. Additional inaccuracies are introduced in the conversion when the household member selected to have carried out all of the behavior had in fact carried out only a minimal amount of such behavior. Clearly, neither one of these known processes are acceptable for many uses. It is therefore desired to overcome the inaccuracies introduced by the above-described data conversion techniques.

### BRIEF SUMMARY

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique that is humanly perceptible, without regard to the form or content of such data, and including but not limited to audio, video, text, images, animations, databases, datasets, files, broadcasts, displays (including but not limited to video displays, posters and billboards), signs, signals, web pages and streaming media data.

The term “database” as used herein means an organized body of related data, regardless of the manner in which the data or the organized body thereof is represented. For example, the organized body of related data may be in the form of a table, a map, a grid, a packet, a datagram, a file, a document, a list or in any other form.

The term “dataset” as used herein means a set of data, whether its elements vary from time to time or are invariant, whether existing in whole or in part in one or more locations, describing or representing a description of, activities and/or attributes of a person or a group of persons, such as a household of persons, or other group of persons, and/or other data describing or characterizing such a person or group of persons, regardless of the form of the data or the manner in which it is organized or collected.

The term “correlate” as used herein means a process of ascertaining a relationship between or among data, including but not limited to an identity relationship, a correspondence or other relationship of such data to further data, inclusion in a dataset, exclusion from a dataset, a predefined mathematical relationship between or among the data and/or to further data, and the existence of a common aspect between or among the data.

The terms “purchase” and “purchasing” as used herein mean a process of obtaining title, a license, possession or other right in or to goods or services in exchange for consideration, whether payment of money, barter or other legally sufficient consideration, or as promotional samples. As used herein, the term “goods” and “services” include, but are not limited to, data.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, activity or thing from another, and are not used to designate relative position or arrangement in time, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” “communicating” and “communication” as used herein include both conveying data from a source to a destination, and delivering data to a communications medium, system, channel, device or link to be conveyed to a destination.

The term “processor” as used herein means processing devices, apparatus, programs, circuits, components, systems and subsystems, whether implemented in hardware, software or both, whether or not programmable and regardless of the form of data processed, and whether or not programmable. The term “processor” as used herein includes, but is not limited to computers, hardwired circuits, signal modifying devices and systems, devices and machines for controlling systems, central processing units, programmable devices, state machines, virtual machines and combinations of any of the foregoing.

The terms “storage” and “data storage” as used herein mean data storage devices, apparatus, programs, circuits, components, systems, subsystems and storage media serving to retain data, whether on a temporary or permanent basis, and to provide such retained data.

The terms “panelist,” “respondent” and “participant” are interchangeably used herein to refer to a person who is, knowingly or unknowingly, participating in a study to gather information, whether by electronic, survey or other means, about that person's activity.

The term “household” as used herein is to be broadly construed to include family members, a family living at the same residence, a group of persons related or unrelated to one another living at the same residence, and a group of persons living within a common facility, such as a fraternity house, an apartment or other similar structure or arrangement.

The term “activity” as used herein includes both active and passive activity, whether intentional or unintentional. Active activity includes, but is not limited to, purchasing conduct, shopping habits, viewing habits, computer and Internet usage, as well as other actions discussed herein. Passive activity includes, but is not limited to, exposure to media, and personal attitudes, awareness, opinions and beliefs.

The term “market activity” as used herein means activity within a market, whether physical or virtual (e.g., the Internet market), and includes, but is not limited to, purchasing, presence in commercial establishments, proximity to commercial establishments, and exposure to products or services. The term “consumer” as used here refers to a person that engages in market activity.

The term “attribute” as used herein pertaining to a household member shall mean demographic characteristics, personal status data and data concerning personal activities, including, but not limited to, gender, income, marital status, employment status, race, religion, political affiliation, transportation usage, hobbies, interests, recreational activities, social activities, market activities, media activities, Internet and computer usage activities, and shopping habits.

In accordance with an exemplary embodiment, a method is disclosed for measuring audience interactivity between at least a first medium and a second medium is provided. Each person that is exposed to the first medium belongs to a first audience, and each person that is exposed to the second medium belongs to a second audience. The method is executed by using at least one electronic device. The at least one electronic device may be any device that is capable of providing audience measurement data, such as, for example, a general purpose computer, a personal digital assistant, a cellular telephone, a Global Positioning System (GPS) device, an Arbitron Portable People Meter, or any set-top box specifically designed for obtaining audience measurement data. The method comprises the steps of obtaining first data relating to an exposure of the first medium to each person belonging to the first audience; obtaining second data relating to an exposure of the second medium to each person belonging to the second audience; using the first data and the second data to determine an overlap audience based on whether each person belonging to the first audience also belongs to the second audience; correlating the first data with the second data with respect to each person belonging to the overlap audience; and calculating a metric based on a result of the correlating step. Each of the first data and the second data may include a time at which the respective exposure occurred for each person of the first and second audiences. The step of correlating may further comprise determining an interval between the exposure of the first medium and the exposure of the second medium for each person belonging to the overlap audience.

Either of the first medium or the second medium may comprise one of a television program; a television channel; an on-demand television video; a digital video recording; a radio program; a radio station; an Internet web site; a enre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium.

The at least one electronic device may be any device that is capable of providing audience measurement data, such as, for example, a general purpose computer having a central processing unit, a personal digital assistant, a cellular telephone, a Global Positioning System (GPS) device, an Arbitron Portable People Meter, or any set-top box specifically designed for obtaining audience measurement data. The metric may comprise a dimensionless numerical coefficient having a magnitude that is correlated with audience interactivity between the first medium and the second medium. Alternatively, the metric may comprise a number of minutes that is correlated with audience interactivity between the first medium and the second medium, or any other parameter or quantity that is correlated with audience interactivity.

In another aspect, the invention provides a system for measuring audience interactivity between at least a first medium and a second medium. Each person that has been exposed to the first medium belongs to a first audience, and each person that has been exposed to the second medium belongs to a second audience. The system comprises at least one electronic device having a processor. The processor is configured to perform the following: receive first data relating to an exposure of the first medium to each person belonging to the first audience; receive second data relating to an exposure of the second medium to each person belonging to the second audience; use the first data and the second data to determine an overlap audience based on whether each person belonging to the first audience also belongs to the second audience; correlate the first data with the second data with respect to each person belonging to the overlap audience; and calculate a metric based on a result of the correlation. Each of the first data and the second data may include a time at which the respective exposure occurred for each person of the first and second audiences. The processor may be further configured to determine an interval between the exposure of the first medium and the exposure of the second medium for each person belonging to the overlap audience.

Either of the first medium or the second medium may comprise one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium.

The at least one electronic device may be any device that is capable of providing audience measurement data, such as, for example, a general purpose computer, a personal digital assistant, a cellular telephone, a Global Positioning System (GPS) device, an Arbitron Portable People Meter, or any set-top box specifically designed for obtaining audience measurement data. The metric may comprise a dimensionless numerical coefficient having a magnitude that is correlated with audience interactivity between the first medium and the second medium. Alternatively, the metric may comprise a number of minutes that is correlated with audience interactivity between the first medium and the second medium, or any other parameter or quantity that is correlated with audience interactivity.

In yet another aspect, the invention provides a computer-readable storage medium for storing instructions that are executable by a computer. The storage medium comprises a computer program for measuring audience interactivity between at least a first medium and a second medium. Each person that has been exposed to the first medium belongs to a first audience, and each person that has been exposed to the second medium belongs to a second audience. The computer program includes instructions for causing an electronic processor to perform the following: receive first data relating to an exposure of the first medium to each person belonging to the first audience; receive second data relating to an exposure of the second medium to each person belonging to the second audience; use the first data and the second data to determine an overlap audience based on whether each person belonging to the first audience also belongs to the second audience; correlate the first data with the second data with respect to each person belonging to the overlap audience; and calculate a metric based on a result of the correlating step. Each of the first data and the second data may include a time at which the respective exposure occurred for each person of the first and second audiences. The processor may be further configured to determine an interval between the exposure of the first medium and the exposure of the second medium for each person belonging to the overlap audience.

Either of the first medium or the second medium may comprise one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium.

The storage medium may be configured to interact with any device that is capable of providing audience measurement data, such as, for example, a general purpose computer, a personal digital assistant, a cellular telephone, a Global Positioning System (GPS) device, an Arbitron Portable People Meter, or any set-top box specifically designed for obtaining audience measurement data. The metric may comprise a dimensionless numerical coefficient having a magnitude that is correlated with audience interactivity between the first medium and the second medium. Alternatively, the metric may comprise a number of minutes that is correlated with audience interactivity between the first medium and the second medium, or any other parameter or quantity that is correlated with audience interactivity.

### BRIEF DESCRIPTION OF THE DRAWINGS

FIG. 1 is a block diagram illustrating an exemplary system for converting household level data to person level data.

FIG. 2 is a block diagram illustrating another exemplary system for converting household level data to person level data.

FIG. 3 is a block diagram illustrating yet another exemplary system for converting household level data to person level data.

FIG. 4 is a block diagram illustrating an exemplary system for integrating datasets.

FIG. 5 is a block diagram illustrating another exemplary system for integrating datasets.

FIG. 6 is a flow chart that illustrates a method of measuring cross-platform interactivity, according to a preferred embodiment of the invention.

### DETAILED DESCRIPTION

Certain embodiments comprise systems and processes to convert household-level data representing media exposure, media usage and/or consumer behavior to person-level data. Certain embodiments comprise systems and processes to combine data from multiple sources, perhaps provided in different formats, timeframes, etc., to produce various data describing the conduct of a study participant or panelist as a single source of data reflecting multiple purchase and/or media usage activities. This enables an assessment of the links between exposure to advertising and the shopping habits of consumers. In certain embodiments, data about panelists is gathered relating to one or more of the following: panelist demographics; exposure to various media including television, radio, outdoor advertising, newspapers and magazines; retail store visits; purchases; internet usage; and panelists' beliefs and opinions relating to consumer products and services. This list is merely exemplary and other data relating to consumers may also be gathered.

Various datasets may be produced by different organizations, in different manners, at different levels of granularity, regarding different data, pertaining to different timeframes, and so on. Certain embodiments integrate data from different datasets. Certain embodiments convert, transform or otherwise manipulate the data of one or more datasets. In certain embodiments, datasets providing data relating to the behavior of households are converted to data relating to behavior of persons within those households. In certain embodiments, data from datasets are utilized as “targets” and other data utilized as “behavior.” In certain embodiments, datasets are structured as one or more relational databases. In certain embodiments, data representative of respondent behavior is weighted.

For each of the various embodiments described herein, datasets are provided from one or more sources. Examples of datasets that may be utilized include the following: datasets produced by Arbitron Inc. (hereinafter “Arbitron”) pertaining to broadcast, cable or radio (or any combination thereof); data produced by Arbitron's Portable People Meter System; Arbitron datasets on store and retail activity; the Scarborough retail survey; the JD Power retail survey; issue specific print surveys; average audience print surveys; various competitive datasets produced by TNS-CMR or Monitor Plus (e.g., National and cable TV; Syndication and Spot TV); Print (e.g., magazines, Sunday supplements); Newspaper (weekday, Sunday, FSI); Commercial Execution; TV national; TV local; Print; AirCheck radio dataset; datasets relating to product placement; TAB outdoor advertising datasets; demographic datasets (e.g., from Arbitron; Experian; Axiom, Claritas, Spectra); Internet datasets (e.g., Comscore; NetRatings); car purchase datasets (e.g., JD Power); and purchase datasets (e.g., IRI; UPC dictionaries).

Datasets, such as those mentioned above and others, provide data pertaining to individual behavior or provide data pertaining to household behavior. Currently, various types of measurements are collected only at the household level, and other types of measurements are collected at the person level. For example, measurements made by certain electronic devices (e.g., barcode scanners) often only reflect household behavior. Advertising and media exposure, on the other hand, usually are measured at the person level, although sometimes advertising and media exposure are also measured at the household level. When there is a need to cross-analyze a dataset containing person level data and a dataset containing household level data, the existing common practice is to convert the dataset containing person level data into data reflective of the household usage, that is, person data is converted to household data. The datasets are then cross-analyzed. The resultant information strictly reflects household activity.

In accordance with certain embodiments, household data is converted to person data in manners that are unique and provide improved accuracy. The converted data may then be cross-analyzed with other datasets containing person data. In certain embodiments described below, household to person conversion (also called translation herein) is based on characteristics and/or behavior. In certain embodiments, household to person conversion is modeled or based on statements in response to survey questions. In certain embodiments, person data derived from a household database may then be combined or cross-analyzed with other databases reflecting person data.

Currently, databases that provide data pertaining to Internet related activity, such as data that identifies websites visited and other potentially useful information, generally include data at the household level. That is, it is common for a database reflecting Internet activity not to include behavior of individual participants (i.e., persons). While some Internet measurement services measure person activity, such services introduce additional burdens to the respondent. These burdens are generally not desirable, particularly in multi-measurement panels. Similarly, databases reflective of shopping activity, such as consumer purchases, generally include only household data. These databases thus do not include data reflecting individuals' purchasing habits. Examples of such databases are those provided by IRI, HomeScan, NetRatings and Comscore.

As described herein, in accordance with certain embodiments, conversion of household data to person data is based on attributes of the household members. Referring to FIG. 1, household (HH) to person process 10, generally carried out by a computing device such as a computer or computer system, obtains a dataset 12 containing data at the household level. Based upon certain household member attributes 14, process 10 employing certain techniques ascertains the head-of-household purchaser of the product under consideration. The resultant selection is then utilized to generate data reflective of this information for inclusion in a dataset 16.

In one particular embodiment, the female head-of-household is assigned to be the principal shopper for items for which women would shop and the male head-of-household is assigned to be the principal shopper for items for which men would shop. In certain embodiments, head-of-household status is applied based upon an assessment of the make-up of the household.

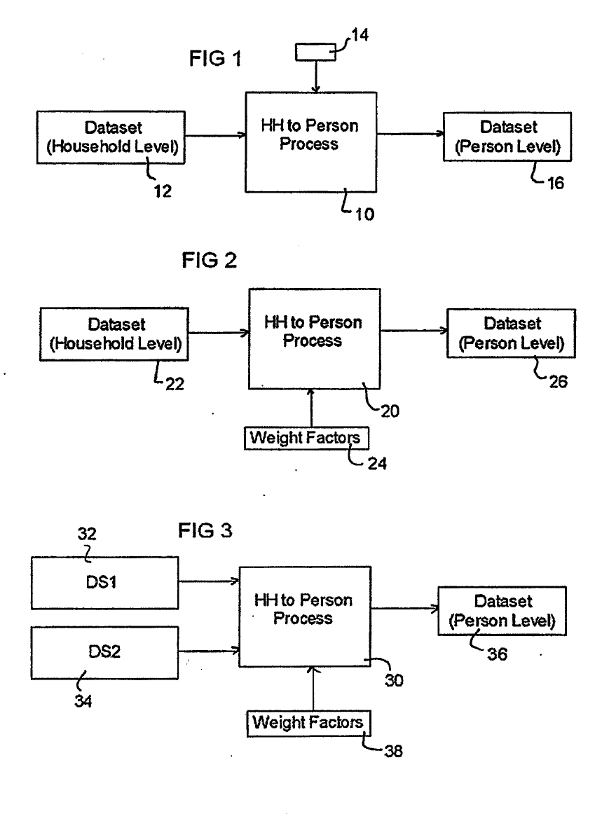

In certain embodiments, and with reference to FIG. 2, data from household dataset 22 is translated into person data for inclusion in dataset 26 by weighting, within process 20, each person in the household based on the probability that the individual carried out the activity. Weighting is based upon various weight factors 24. Then, the member with the highest weight for an identified behavior, such as a product purchase, is deemed to be the person who carried out the behavior. In various embodiments, the type of behavior will impact the value of the weights applied to the members. In certain embodiments, the weights are derived (or re-weighted) so that their sum equals one.

In certain embodiments, children household members are included. In the various embodiments that weight household members, children likewise are assigned weights.

For example, when a household includes individuals under 18 years of age (i.e., children), a maximum designated weight for children is assigned, and lower values decrementally are assigned to younger individuals. In one variation, a maximum value is established for a 17 year old individual, and children of other ages are assigned a value equal to the maximum value multiplied by the respective child's age divided by 17. For example: if the maximum weight is 0.51 (e.g., for a 17 year old), then a 10 year old child is assigned a weight of 0.3. That is, (0.51*10)/17=0.3. In other variations, this weighting scheme may be applied to children (or even young adults) of other ages. For example, an adult can be deemed to be a person 21 years old or older, with younger individuals being assigned weights using this formula or a similar formula. As another example, it may be appropriate to use a similar formula for children 16 (or even 15) years of age and younger. In yet another variation, the age of a “child” (i.e., when the formula is applied) is dependent upon the type of product purchased.

In accordance with certain embodiments, household member weights are derived based upon employment status. Various employment statuses include: full-time; part-time and unemployed. Other statuses include: night-time employed and day-time employed. Other employment status/factors may also be utilized, such as type of employer (e.g., government, corporate, private, partnership, sole-proprietor, etc.), type of occupation or profession, distance (time and/or miles) to travel to work, location of employment (city, suburbs, country, in home, etc.), and so on. In one example, an unemployed household member (e.g., a “stay-at-home” spouse) is assigned a weight of 1.0; a part-time employed member is assigned a weight of 0.7; and a full-time employed member is assigned a weight of 0.3. Preferably, weighting based upon employment status is applied only to individuals 18 years of age or older.

In certain embodiments, weights are applied to household members based upon gender. For example, a greater weight is assigned to women than to men in circumstances where it is more likely a product or service would be purchased by a woman. The value of the weights assigned may vary depending on the behavior carried out. For example, these weight values are assigned when the behavior is the purchase of a product typically purchased by women. For a product typically purchased by men, these weight values may be reversed.

In certain embodiments, multiple weights are assigned to each household member and then all of the weights assigned to an individual are multiplied together to produce a collective weight for that individual. The household member with the highest collective weight is deemed the person who carried out the behavior. For example, a dataset includes data that indicates that a household had purchased a product that is normally purchased by women, and the household has three members: a man, a woman and a 7 year old child. The woman is employed full time. The man is employed part-time. Conversion of the data from household data to person data is carried out by employing two sets of weights: (1) gender; and (2) employment status. The woman is assigned a gender weight of 1.0 and an employment status weight of 0.3 (full-time employed). The resultant collective weight for the woman is 0.3. The man is assigned a gender weight of 0.5 and an employment status weight of 0.7 (part-time employed). The resultant collective weight for the man is 0.35. Children weights also are utilized, with a preset maximum weight of 0.51 (or other suitable weight) applied to children age 17. The 7 year old child is assigned a child weight of 0.21 ((7*0.51)/17=0.21), and a second weight as a child (e.g., for employment status) of, for example, 0.5. The child's collective weight thus is 0.105. The man has the largest collective weight for the behavior under consideration and, thus, the man is deemed to have carried out the behavior. Data reflective of this result is generated and included within dataset 26.

The above example illustrates the usage of two sets of weights: gender and employment status. Other sets of weights may be utilized, such as any of those mentioned herein and others not mentioned. In addition, three, four or more sets of weights may be utilized concurrently.

In certain embodiments of the present invention, multiple sets of weights are utilized and assigned to each household member, and those weights are summed together to produce the member's collective weight. Preferably, after all of the collective weights are computed, the collective weights are re-weighted so that their sum equals one. The household member with the highest collective weight is deemed to be the person who carried out the behavior under consideration.

In accordance with certain embodiments of the present invention, household data containing data representative of household computer usage is converted to person data. Computer usage generally is tracked at the computer level, independent of who used that particular computer and, thus, electronic measures of computer usage (and other means for measuring usage) generate data at the household level. If Internet usage is being tracked, the resultant Internet usage data likewise represents household data.

A dataset containing data representative of household computer usage, in particular Internet usage, may be converted to person data in accordance with certain embodiments described herein. In such embodiments, weights may be applied to household members based upon employment status, gender, age, and/or other factors, including but not limited to those mentioned above. In addition, the gender or other attributes of persons may be taken into account in assessing the likelihood they visited specified websites.

In accordance with certain embodiments, household data is converted into person data by employing a second dataset containing survey data. Referring to FIG. 3, a first dataset 32 (DS1) contains data representative of the household's computer usage and a second dataset 34 (DS2) contains survey data. The survey data reflects respondents' answers to survey questions about their computer and/or Internet usage, as well as e-mail usage. Since survey data reflects each individual's behavior or activity, such survey data represents data at the person level. Examples of survey data and datasets, as well as manners of taking surveys, are well known and thus are not discussed in detail herein.

As mentioned above, the first dataset 32 contains data pertaining to a household's computer usage and/or Internet usage and the second dataset 34 contains survey data. The survey data reflects each household member's perceived or believed amount of usage during a period of time. The survey usually includes other information. For example, dataset 34 contains regular diary measurement data and includes the fields: person ID; household ID; prior usage (e.g., amount of time on computer during a certain calendar period); and date of the survey. As for the other dataset, dataset 32 contains continuous electronic computer measurement data, and includes the fields: computer household ID (identification); date; time and usage.

In accordance with one embodiment, process 30 ascertains each household member's actual usage based upon each household member's indicated usage (in the survey data), the household's total indicated usage (also in the survey data) and actual total amount of Internet usage (in the computer measurement data). The usage of each person is particularly ascertained to be equal to the amount of usage of the respective household member identified on the survey normalized to the actual amount of total usage time identified by the first dataset 32. If the first dataset represents electronic measurement data, the first dataset represents accurate, unbiased data, whereas the survey data usually is not completely accurate due to human error. More particularly, each household member's usage is equal to the respective member's survey reported usage multiplied by the total electronic data identified usage divided by the sum of all member's survey reported usage.

In certain embodiments, integration is carried out in accordance with the following. (1) If the electronic computer measurement system was installed (and operating properly) and the dataset produced from measurements of that system identified that the household had no computer usage, then each person in the household is deemed to have had no usage regardless of the results of the survey. (2) If the electronic computer measurement system was not installed (i.e., not functioning or not set up), then the survey data alone is utilized to assess the amount of usage of each person in the survey. (3) If the electronic computer measurement system was installed and operating properly, and the dataset produced from measurements of that system identified that the household had computer usage, then each member's usage is ascertained as described above. (4) As a variation of (2) above, if the electronic computer measurement system was not installed (i.e., not functioning or not set up), then the survey data is utilized and adjusted based on average usage patterns when the computer system was set up or working properly.

In certain embodiments, data identifying household purchases over a period of time is converted to person level data by utilizing survey data. A first dataset reporting continuous electronic measurement of product purchasing (e.g., by barcode scanning) of households includes the following fields: household identification (HH ID); date; time and purchased items. A second dataset reporting periodic diary measurement includes the following fields: person ID; household ID, times shopped; type of items purchased; and date of survey. For the diary measurement, members of households individually report their purchasing activities, but usually in a somewhat general manner. For example, the type of items purchased may be a list of types of products, with or without indications of brand names, sizes, prices, model numbers, etc. As used herein, a “diary” or “diary measurement” includes a panelist maintaining a manual record (written or oral), but also includes a panelist answering questions posed during one or more interviews, whether taken over the telephone, on-line or in-person, or by any other method.

In certain embodiments, the type of an item under consideration purchased by a household as identified by the electronic measurement (i.e., the first dataset) is matched to each member of that household who identified in the survey (i.e., the second dataset) that he/she purchased such type of item. Each person's ascertained probability of having purchased the item under consideration is based on the relative share of reported shopping by that member. The member in the household with the highest probability is deemed the purchaser of the item under consideration.

In a particular refinement of this embodiment, ascertained probabilities of household members not deemed to be the purchaser of an item under consideration are “carried forward” and accumulated with subsequent probabilities ascertained for each household member for another purchased item falling within the same type. For example, if household members m1, m2, m3 and m4 are assessed to have probabilities of likelihood of purchasing a product p1 of 30%, 40%, 25% and 5%, respectively, then member m2 is deemed to have purchased product p1. If purchased product p2 is of a different type (e.g., p1 is ice cream and p2 is shaving cream), then the previously ascertained probabilities of the members of having purchased p1 (ice cream) have no impact on the assessment of who purchased p2 (shaving cream). However, if product p3 is of the same type as p1 (e.g., p3 is frozen yoghurt), then the previously assessed probabilities of members m1, m3 and m4 are added to their assessed probabilities of having purchased p3. As noted above, the second dataset comprises diary data and includes, for each member, types of items purchased and times shopped. If multiple members report that they have purchased a particular type of product (e.g., frozen dessert) within a certain time frame, the “carrying forward” of probabilities for members not deemed to have purchased a given product appropriately distributes purchased products amongst those household members who have indicated in the survey that they have purchased certain types of products. Thus, a household member who has, for example, a 10% probability of purchasing a certain type of product will likely not be deemed the purchaser several times for products of such type, but will eventually be deemed the purchaser of a product of such type after his/her probability has increased sufficiently.

In a variation of the embodiment discussed above, a product purchase is assigned based on the household members' assigned probabilities and a random number. Each household member is assigned a respective “proportion range” based upon the probability that the member purchased a particular item, and a randomly selected number designates the purchasing member in the following manner. Using the respective probabilities of the household members mentioned above (i.e., 30%, 40%, 25% and 5%) with respect to product p1, household member m1 is assigned the range 0-29 (representing a 30% probability), member m2 is assigned the range 30-69 (representing a 40% probability), member m3 is assigned the range 70-94 (representing a 25% probability), and member m4 is assigned the range 95-99 (representing a 5% probability). A random number between (and inclusive of) 0 and 99 is selected and designates the member who is deemed to have purchased product p1. For example, a random number of 27 deems member m1 the purchaser. Equivalent probability selection methods may be utilized.

In certain embodiments described herein, electronic product purchase data combined with survey data effectively enables the conversion of a product purchase household level dataset into a product purchase person level dataset. Preferably, the surveys are taken on a periodic basis.

In another embodiment of the present invention, a dataset identifying household Internet usage is converted to person level data using survey data and also utilizing so-called primary user and weighted user measurements. The primary Internet user is deemed to be the member of the household with the highest number of hours of usage of the Internet as stated in the survey dataset. If, however, that person did not respond to the survey, then a single member of the household may be selected as the primary user based on age using the youngest person over age 18. The Internet users are weighted by using the mid-level of hours in the range specified in the survey as the weight; adjusting each person's weight (within the household) so that the sum of the weights is 1.0; and if none of the persons in the household responded to the survey, then each person is given an equal weight.

In certain embodiments relating to purchasing behavior, a principle shopper is designated utilizing the following rules. (1) In a single person household, that person in deemed the principal shopper. (2) An adult aged 18 years or older preferably is selected as the principal shopper. (3) Multiple adults within a household are ranked by employment status, with non-employed being ranked highest, followed by part-time employed, and then full-time employed. In the case of a tie, the female is selected. If there is a tie between two female adults, the person with the lower identification (e.g., higher priority) is deemed the principle shopper, where, in general, the head of household retains a lower identification, with adult children as well as grandparents having higher identifications.

In certain embodiments, weights are utilized to assess members' likelihood of purchase of a particular product and the following criteria are followed in assigning those weights: (1) In a single person household, that person is provided a weight of 1.0 (i.e., selected as the purchaser). (2) For children under age 18, weights are assigned as a function of age, with younger children receiving smaller weights than older children. The function preferably is linear so that a child's weight is equal to his/her age multiplied by a preset number. (3) For adults, unemployed persons are given the highest weight, followed by part time persons, and full time employed individuals are provided the lowest weight amongst the adults. These weights also may take into account the type of product purchased. (4) Each adult man's weight is factored by 0.33. (5) All weights in each household are adjusted to sum to 1.0.

The various embodiments discussed above relate to the conversion of one or more datasets containing household level data to one or more datasets containing person level data and/or the integration of household level data with person level data. Certain ones of these embodiments can be utilized to convert data representative of a single instance of household behavior to person level data.

Whether or not one or more datasets are (or need to be) converted to datasets containing person level data, certain embodiments of the present invention entail the creation of a single reporting structure to enable the integration of multiple datasets. These embodiments and others described herein provide a structure to allow a user to meaningfully use all of the information provided within the datasets, without getting lost in the endless possibilities that may exist when data from different datasets are integrated. Various embodiments discussed herein frame the questions utilized to build a report while, at the same time, remain open to the particular level of detail and the type of reports generated. Certain embodiments further assist in determining the weights for each person within the datasets.

In accordance with certain embodiments of the present invention, a report includes two elements: (1) a set of characteristics; and (2) a set of behaviors.

A characteristic (also called a “framework characteristic”), as this term is used within the various embodiments described relating to reporting frameworks, determines the persons who are included in the report. Multiple characteristics may be utilized. The data may come from any period of time from any survey or panel measurement. For example, a characteristic may be people who bought bread in the last two years. Another characteristic may be people who have a good credit rating. A further characteristic may be people who are heavy users of cable television. Yet another characteristic may be people who listen to a particular radio program. Yet a further characteristic may be people who shopped at a particular retail store. There are numerous characteristics that may be utilized and thus the foregoing characteristics are for illustrative purposes only.

A behavior (also called a “framework behavior”), as this term is used within the various embodiments described relating to reporting frameworks, identifies something (activity, exposure, beliefs, etc.) that is reported for those persons who are included in the report as determined by the framework characteristic. For example, one behavior might be “viewed a commercial for bread.” Another behavior may be “purchased bread in a specific month.” A further behavior may be “watched a designated amount of a specified television broadcast or channel.” There are numerous other behaviors that may be utilized and thus the foregoing behaviors are for illustrative purposes only.

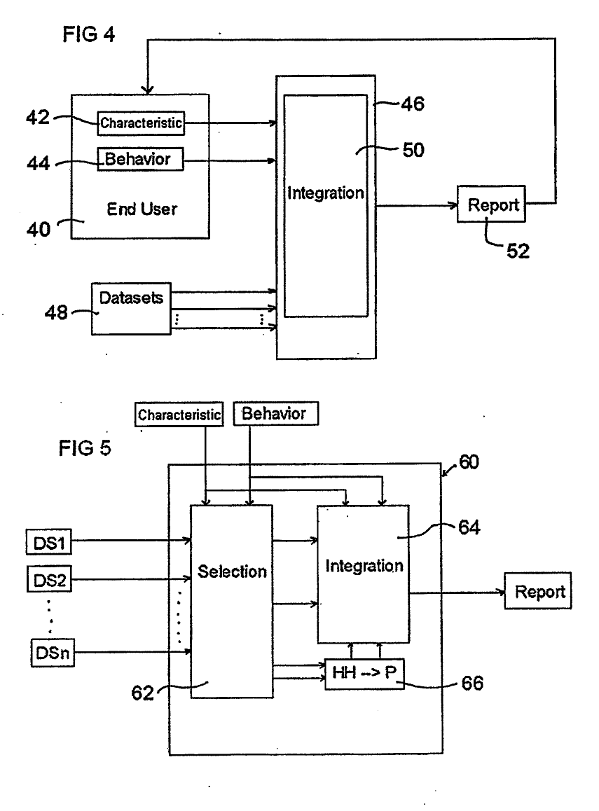

In certain embodiments, and referring to FIG. 4, an end user 40 identifies a characteristic 42 and a behavior 44 for utilization by a system 46 which carries out integration in accordance with certain embodiments described herein. System 46 may be disposed separate and apart from user 40. System 46 has access to multiple datasets 48, which may be stored within system 46 or, as shown, separate and apart from system 46. One or more datasets 48 may be provided to system 46 on demand or may be immediately accessible. As mentioned above, the various datasets may be provided by one or more sources.

System 46 integrates, utilizing an integration process 50, certain ones of the datasets based upon the designated characteristic and behavior and produces data for a report 52. The generated report 52 may be supplied to user 40 for further consideration and analysis. As described herein, the datasets integrated during the integration process may be specifically provided for integration or may be selected based upon various criteria.

Certain embodiments include, employ or contain one or more of the following advantageous features: the selection of datasets relating to different time periods; the selection of these time periods at the time of processing, also known as “on-the-fly;” the selection of time periods that start or end on any designated day; the selection of time periods without restriction to fixed periods of time; the selection of one or more characteristics and/or one or more behaviors on-the-fly; the creation of relational databases; the selection of surveys on-the-fly for use as criteria for compliance and inclusion in a report; the selection of panel results for analysis without restriction; the selection of multiple panel results for combination; the selection of measures of panel results for use and inclusion in reports without unnecessary restrictions.

In certain embodiments, panelist data is weighted to accurately reflect the population and usage, by adjusting the panelist data to correct for disparities between the demographic composition of the panel and that of the population under study. In certain embodiments, activities of the same respondents (panel members) participating in multiple surveys/panels during the same or different period of time, by different means to record or measure the activities, and with different levels of compliance, are integrated into a single reporting framework.

As discussed herein, different means to record or measure activities or exposure to media includes various types of instrumentation utilized for the measurement. For example, Arbitron's Portable People Meter is one type of electronic instrumentation. Many other types of electronic instrumentation are available. Non-electronic means for recording or measuring activity or exposure to media also are available, such as a survey.

Different measuring means will likely have different compliance requirements. For example, in the case of Arbitron's Portable People Meter, one compliance requirement is that the panel member carries around the meter at some point in a given day. In the case of, for example, tracking print readership, a compliance requirement is for the panelist to record their print reading activity on a given day. The panelist may comply with one requirement and not the other. Thus, even for the same period of time, it is possible for a panelist participating in two different studies (or a single study utilizing multiple data gathering techniques) to have different levels of compliance. For example, in a given month (e.g., April), the panelist may be compliant in one panel study for 24 days of that month and be compliant in another panel study for 11 days of that same month. The lengths of the panel studies in which the panelist is participating may be different. For example, one panel study in the example may have a period spanning six months from January through June, whereas the other panel study has a two-month period, April and May. Of course, these are only exemplary periods and levels of compliance and, thus, are for illustrative purposes only.

In certain embodiments, the concept of “intab” is employed. As is well known, intab refers to data deemed acceptable for use in reports because the panelist has adhered sufficiently to the prescribed compliance requirements.

In one example, a panelist participates in a first study relating to ascertaining exposure to advertisements and also participates in a second study relating to purchasing behavior. Certain embodiments integrate datasets containing data regarding these two studies, employ the above-mentioned characteristic and behavior framework and also employ weighting. In the example where a panelist participated in two different studies, it may be desired to assess the nexus between advertisement of a product and the purchasing of that product or similar products. To integrate the two datasets, the framework characteristic for the report to be generated is designated to be those persons who have purchased the product in question or those types of products in general, or other variation of this characteristic. The framework behavior is designated to be exposure to the specified advertisements, such data being available in the second dataset.

In certain embodiments, the user specifically identifies the datasets to be integrated. In certain other embodiments, the user does not identify the datasets to be integrated, but rather allows a selection process to select the datasets based upon the designated framework characteristic and framework behavior. Referring to FIG. 5, a system 60 includes a selection process module 62 for carrying out the above-mentioned selection of datasets for integration. A multitude of datasets DS1, DS2 . . . DSn are available for selection. Each of these datasets may be supplied by different sources and the datasets themselves may be maintained within one or more systems separate and apart from system 60. The selection process selects one or more datasets suitable for use for the designated framework behavior and, similarly, selects one or more datasets suitable for use for the designated framework characteristic. Also, as mentioned above, selection of the datasets may be done by the user at the time of processing.

After selection of the datasets to be integrated, an integration process module 64 integrates the selected datasets in accordance with certain embodiments of the present invention. In the event one or more selected datasets contain household level data, it may be desired or necessary to convert such datasets to reflect person level data utilizing a household to person conversion module (HH—>P) 66. Household to person conversion may be carried out in accordance with any appropriate previously described embodiment. A report is produced upon integration of the datasets. It is appreciated that the various modules mentioned may be carried out in separate devices or systems, or within the same device or system. In one example, system 60 is implemented by a processor that carries out the functions of all of the process modules thereof. In another example, the various processes are carried out by different processors that may be separate and apart from one another.

In certain embodiments, the compliance level of each participant of the framework behavior is not taken into account. Participants that are identified as having carried out or possess the designated framework characteristic are included in the report irrespective of each participant's compliance level in the study that measured the framework behavior. Each participant's compliance level and other factors in the framework behavior are, however, taken into account to ascertain the weights. In certain embodiments, intab status is taken into account.

Weighting is ascertained as a function of the participants' measured activity and characteristics with respect to the framework behavior. In particular, the period of time considered for weighting is based upon the period of the panel study pertinent to the framework behavior, rather than the period of the panel study pertinent to the framework characteristic. Hence, certain embodiments advantageously take into account only one period of time (i.e., the period of the study pertaining to the behavior) in ascertaining the weights to be utilized. Thus, integration of datasets that pertain to different time periods is carried out in a relatively simple manner.

In a more detailed example, provided for purposes of illustrating integration using the characteristic and behavior framework described herein, panelists participate in a first study that measures panelists' exposure to advertisements of a particular brand of dog food on both television and the Internet during the month of September (of the current year). The panelists also participate in a second study in the form of a survey that requests whether the survey participants purchased dog food of any brand in the last two years. In the example, the framework characteristic is who bought dog food in the last two years and the framework behavior is exposure to the television and Internet campaign. The second dataset provides data that relates to the framework characteristic and the first dataset provides data that relates to the framework behavior.

The integration process selects for inclusion in the report those survey participants who indicated they had purchased any brand of dog food in the last two years. However, the survey data is not utilized for weighting considerations. Thus, the only period of time utilized to identify respondents who will be weighted is the period of the first study.

The framework behavior in the example includes both television and Internet advertising. In certain embodiments, weighting takes both of these measures into account. Levels of compliance and intab status for each of these measures are relevant for establishing the factors in deriving the weights of the panelists included in the report.

A single weight is calculated for each participant to compensate for the television measure compliance level and the Internet measure compliance level. The single weight also is provided for the entire period, as opposed to providing daily weights. Typically, existing systems employ multiple and/or daily weights for media panel data where the number of people reporting accurate data on any given day may vary. Since a rating is a measurement of the percentage of people doing something on a given day, it is important to determine the correct number of people to count. The value of a multiple/daily weight is in the accuracy of each number reported. However, these behaviors preferably are not compared across different times, and also preferably are not compared to behaviors that were measured in another way that might have a different weight for that same day. Certain embodiments of the present invention, on the other hand, provide only a single weight for the entire period under consideration.

In certain embodiments, panelists who are not intab during the behavior period are not included. Thus, in the example, respondents who purchased dog food in the last two years and also who are intab in September for the study relating to television and Internet exposure are included in the report. In a variation, intab for each measure is considered. That is, if a respondent was intab for the television measure, but not for the Internet measure, then the panelist is included in the report, but only the television measure and compliance levels are considered for the weight. The behavior pertaining to the Internet measure is not utilized to determine the weight.

The level of compliance for each person in the report is ascertained across the entire period for the behavior. In the example, the entire period of the framework behavior was the month of September. Thus, the number of days each person (to be included in the report) was compliant in September for the television and Internet advertising study is considered. More particularly, the number of days in September a panelist was in compliance with respect to the television advertisement measure is ascertained, and the number of days in September a panelist was in compliance with respect to the Internet measure is separately ascertained. Each person is then assigned a compliance factor that is the inverse of his/her compliance. For two measures, in certain embodiments if a person was compliant×percent of the time for the television measure and y percent of the time for the Internet measure, that person's compliance factor is equal to the total days in the period (September) multiplied by two (for two measures) divided by the sum of the two compliance percentages. That is, the factor=(total days in period*2)/(x+y). Preferably, the factor is limited to a predetermined maximum compliance factor to minimize inaccuracies that may be caused due to excessively low compliance. Alternatively, respondents with low compliance may be excluded from the sample entirely.

In certain embodiments, the panelists' derived compliance factors are modified to adjust the weight for each respondent to conform to the demographics, behavioral breakdowns or other population category for such respondents. In particular, a population multiplier is ascertained for each person by dividing the total population for a given group (cell) by the sum of the factors for the respondents in that group. Each person's compliance factor is then multiplied by the ascertained population multiplier. Prior to ascertaining population weights, cells within the computation that do not have members are combined with other cells. In certain embodiments cells are combined within sex, by age from younger to older.

The final ascertained factor of each panelist is the weight applied to the behavior of that person. Totals of other measures (either electronic or otherwise), where compliance levels and/or populations are not considered, are attributed without the compliance factors.

In certain embodiments, the various factors (weights) are not combined so that behaviors of a respondent are not all multiplied by the same weight. In certain embodiments, behaviors that are part of the compliance determination are weighted by the combined weight. In certain embodiments, characteristics that are not included are multiplied by the population weight, which is the cell population divided by the number of respondents in that cell.

In certain embodiments, the period of the framework characteristic is selectable and may be the same or different from the period of the one or more panels which measured the specified behavior. In certain embodiments, the period of the frame behavior is selectable and may be the same or different from the period of the one or more panels which measured activity/exposure pertaining to the specified behavior. In certain embodiments, the period of the characteristic and the period of the behavior are selected, and integration is carried out in the manners previously described utilizing the selected periods.

As can be appreciated from the discussion herein, various difficulties have been overcome by the herein described inventive framework. In particular, when a panelist is included within multiple panels and/or surveys, certain embodiments of the present invention overcome the problem of assessing how to decide who is intab and what weights the individual is to be given. Certain embodiments further overcome difficulties in assessing different databases reporting different measures. Certain embodiments overcome general difficulties in handling reports pertaining to different periods of time. Certain embodiments overcome difficulties in assessing and reporting multiple forms of activities measured by different methods.

Traditionally, one conventional objective of content providers, such as advertisers, is to expose a particular advertisement or other content to as many separate individual persons as possible, because the greater this number, the greater the pool of potential consumers of the content or advertised product. The number of separate individuals to whom a given ad or other content has been exposed may be referred to as the “unduplicated” audience for that ad or other content. In this aspect, as between a first medium and a second medium, advertisers and content providers have conventionally been interested in knowing the “incremental” audience that the second medium provides with respect to the first medium; i.e., how many individuals that were not exposed to the ad via the first medium were exposed to the ad via the second medium. For example, if 100,000 people viewed a particular advertisement on NBC, and 50,000 people heard the same ad on WABC-AM, but 20,000 of those 50,000 were also among the 100,000 viewers of the ad on NBC, then the incremental audience that WABC provided is equal to 50,000−20,000=30,000, and the unduplicated audience for that ad is 100,000+30,000=130,000.

However, there is now an increasing trend toward measuring “engagement” of consumers with a given brand. In this context, “engagement” refers to a quality of a connection established between the consumer and the content or advertised brand, or a degree to which the content or advertisement affected the consumer's behavior. Accordingly, some content providers and/or advertisers are also interested in ascertaining the qualities of a “duplicated” audience, i.e., persons to whom at least two exposures of the particular advertisement or content have been made. Using the prior example, the duplicated audience for the ad broadcast on both NBC and WABC-AM is 20,000. Furthermore, there is an especially strong interest in measuring the duplicated audience across media platforms. For example, although a particular consumer may see the same ad on two different television programs, a higher degree of engagement may be indicated by a particular consumer seeing the ad once during a television program and then a second time on a particular Internet web site, because the viewing on the web site may suggest a more proactive, engaged interaction by that consumer with the particular content of interest.

In a preferred embodiment of the invention, a method for measuring cross-media interactivity is provided. In this context, “cross-media” refers to an exposure of one or more persons to at least a first medium and a second, distinct medium. Similarly, the term “cross-platform” refers to at least two distinct mechanisms by which the respective exposures to the first medium and the second medium are implemented. In this context, the terms “interactive” and “interactivity” refer to any action by a person that relates to both the exposure to the first medium and the exposure to the second medium. For example, if the person watches a television program and then accesses an Internet web site associated with the program, then the acts of watching and accessing both qualify as interactions by the person. In this aspect, both “interactive” and “interactivity” may refer to either or both of active acts and passive acts.

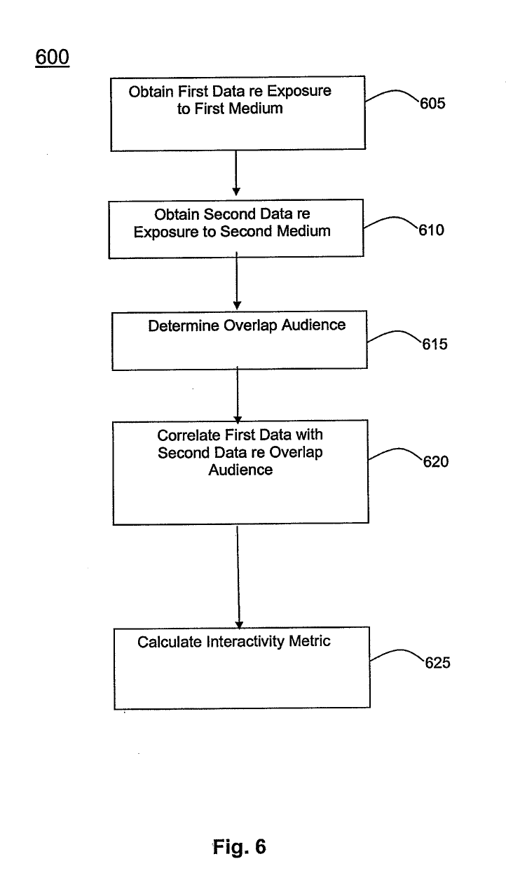

Referring to FIG. 6, a flow chart illustrates a method according to a preferred embodiment of the invention. The method is preferably executed by using an electronic device, such as a general purpose computer or an Arbitron Portable People Meter. In step 605, first data relating to an exposure of a first medium to each person in a first audience is obtained. In this context, the first audience is defined as being the set of people that were exposed to the first medium. For example, the first medium of interest may be a specific episode of a television program entitled “Saving Grace” which was broadcast on the TNT cable television network from 5:00 pm to 5:30 pm Eastern Time on a Tuesday afternoon, and a person named John Doe may have watched this program, thereby qualifying him as one of the first audience. The first data may also include, for example, demographic data relating to the person, such as the person's age, gender, race, address, etc. In step 610, second data relating to an exposure of a second medium to each person in a second plurality of people is obtained. In this context, the second audience is defined as being the set of people that were exposed to the second medium. For example, the second medium may be a particular Internet web site that was advertised during the broadcast of the Saving Grace program. In addition, John Doe may have accessed the particular web site of interest from 5:35 pm to 5:45 pm on that Tuesday afternoon, thereby qualifying him as also being one of the second audience. In step 615, an overlap audience is determined by using the first data and the second data. In this context, the overlap audience is defined as being the set of people that were exposed to both the first medium and the second medium, i.e., the intersection of the first and second audiences. In step 620, the first data is correlated with the second data with respect to the overlap audience. For example, the correlation may include determining how many persons are members of the overlap audience, and also what percentage of each of the first and second audiences are members of both; and the correlation may also include statistical calculations relating to the interval between the broadcast of the program and the accessing of the web site. Finally, at step 625, a result of the correlation step is used to calculate an interactivity metric. In a preferred embodiment, the interactivity metric would provide a numerical measure within a predefined range to indicate a degree to which there was interactivity between the first medium and the second medium.

The first medium and the second medium may be any type of medium for which a measure of cross-platform interactivity is desirable. For example, such a medium may include: television, such as a particular broadcast of a television program, a particular television channel or network, video on-demand, digital video recordings (including, e.g., Tivo) or television in general; radio, such as a particular radio program, a particular radio station, or radio in general; the Internet, such as a particular web site(s) or a genre of web sites, as well as videos, audios, and advertisements, including clickable advertisements; print media, including newspapers; magazines, periodical publications, and books; outdoor advertising, such as billboards and signage; movie theater presentations, including pre-show advertising and trailers and product placements; in-store shopping, including interactive kiosks in shopping malls and centers; touch-screen mobile telephones and mobile devices, including MP3 players such as iPods, personal digital assistants (PDAs), “smart” phones and eyeglasses with interactive screens; voice modules; e-mail transmissions, including computer instructions sent from work to home; and games, including computer games and Internet-based or on-line games.

Interactivity may include an affirmative act performed by a given person. Such affirmative acts may include, for example, attendance at a given event; sending a text message to a particular recipient; telephoning a particular telephone number; accessing a particular Internet web site; and/or sending an e-mail to a particular recipient. In addition, interactivity may also include a passive act performed by a given person. Such passive acts may include, for example, viewing a television program; listening to a radio program; driving by a billboard; reading a newspaper or magazine or other publication; receiving an e-mail or text message; and/or attending a movie or other event at which the medium of interest is not the main attraction.

The raw data to be correlated can be obtained by any known method, including panel-based measurement techniques and broader census-based measurements. Summary data can be used in conjunction with statistical modeling techniques, such as multiple regression, to provide estimated measurements.

Specific examples are provided herein. These examples are for illustrative purposes only. In particular, Table 1, Table 2, Table 3, and Table 4 provide exemplary reports that include cross-platform interactivity metrics according to a preferred embodiment of the invention. In each of these tables, the report provides data tallies relating to usage of a first medium and a second medium, as well as data relating to content within the second medium that is associated with the first medium. Table 1 includes five parts, labeled Table 1a, Table 1b, Table 1c, Table 1d, and Table 1e, which are intended to be read as if concatenated horizontally into a single table.

The following metrics are used and calculated in the various Tables 1-4. These metrics are ultimately calculated using at least one media exposure database. A plurality of databases could be employed, if desired. It should be appreciated that the following metrics are not an exhaustive list; but, are used only for exemplary purposes. Additional metrics could be used, or, some of the listed metrics could be removed depending upon the particular data calculation required by a client.

Min (000): Minutes, the total number of minutes viewed within a particular and pre-determined time period. Seconds could also be measured, if desired.
Average Aud (000): is the average number of people who viewed during any given minute for the particular time period analyzed or measured.
Aud (000): the unduplicated audience (i.e., cumulative audience).
Average Aud: Average Audience, may also be called a “Rating.” It is the average number of people who were exposed each minute during the particular time period measured, and is expressed as a percentage of the given population, which may also be referred to as (“Average Minute Audience”).
GI: Gross Impressions. It is the gross amount of consumption of the program or commercial (or any content). Minutes×cume audience.
GRP: Gross Ratings Points. It is GI expressed as a percentage of the particular population.
Aud Share Audience share. It is the percent of total exposure during the time period analyzed that is accounted for by the particular media measured. It is typically expressed as a percentage.
Coefficient: The outcome of the statistical model that relates the use of one medium's exposure to another medium. Coefficient is a dimensionless numerical quantity that provides a relative measure for a given pair of media with respect to another pair of media.
Coefficient Index: The index of the coefficient to the overall relationship of interactivity across all media within the analysis period
Incremental Interactive Minutes: The number of minutes that are a function of the first medium's use, above and beyond interactive medium's normal usage. Can be expressed for other metrics as well, such as Aud(000), Average Audience, Share, etc.
Note: Any medium/program or combination of media/programs can be the “Target” and any medium or media can be the “Interactive Medium”, per the radio example provided in Table 4.
Monday-Friday 8 pm-11 pm (“Prime Time”)

### May-08

### Females 2549

TABLE 1
Table 1a

| | | | | TARGET MEDIA AUDIENCE | | | | | | |
|---|---|---|---|---|---|---|---|---|---|---|
| Media | | | | | | | | Average | Average | Aud |
| Type | Network | Daypart | Target Media | Min (000) | Aud (000) | GI | GRP | Aud (000) | Aud | Share |
| Cable | TNT | Prime | Saving Grace | 200 | 2800 | 560000 | 22.4 | 1700 | 6.8 | 27.4% |
| | | Time | Charmed | 120 | 2900 | 348000 | 13.9 | 1600 | 6.4 | 25.8% |
| | | | The Closer | 270 | 4000 | 1080000 | 43.2 | 2000 | 8.0 | 32.3% |
| | | | Other | 185 | 1900 | 351500 | 14.1 | 900 | 3.6 | 14.5% |
| Total | Total | | Total | 775 | 10000 | 2339500 | 93.6 | 6200 | 24.8 | 100.0% |
| | | | | Population | 25000 | | | | | |

Table 1b

| | | | | INTERACTIVE MEDIA TOTAL AUDIENCE | | | | | | |
|---|---|---|---|---|---|---|---|---|---|---|
| Media | | | | | | | | Average | Average | Aud |
| Type | Network | Daypart | Target Media | Min (000) | Aud (000) | GI | GRP | Aud (000) | Aud | Share |
| Cable | TNT | Prime | Saving Grace | 12 | 1200 | 14400 | 0.6 | 800 | 3.2 | 25.0% |
| | | Time | Charmed | 30 | 3000 | 90000 | 3.6 | 500 | 2.0 | 15.6% |
| | | | The Closer | 48 | 5000 | 240000 | 9.6 | 900 | 3.6 | 28.1% |
| | | | Other | 20 | 800 | 16000 | 0.6 | 1000 | 4.0 | 31.3% |
| Total | Total | | Total | 110 | 1200 | 360400 | 14.4 | 3200 | 12.8 | 100.0% |

Table 1c

| | | | | INTERACTIVE MEDIA AUDIENCE | | | | | | |
|---|---|---|---|---|---|---|---|---|---|---|
| | | | | (THAT IS RELATED TO TARGET MEDIA) | | | | | | |
| Media | | | | | | | | Average | Average | Aud |
| Type | Network | Daypart | Target Media | Min (000) | Aud (000) | GI | GRP | Aud (000) | Aud | Share |
| Cable | TNT | Prime | Saving Grace | 10 | 900 | 9000 | 0.4 | 100 | 0.4 | 22.2% |
| | | Time | Charmed | 16 | 190 | 3040 | 0.1 | 50 | 0.2 | 11.1% |
| | | | The Closer | 24 | 540 | 12960 | 0.5 | 200 | 0.8 | 44.4% |
| | | | Other | 14 | 300 | 4200 | 0.2 | 100 | 0.4 | 22.2% |
| Total | Total | | Total | 64 | 1200 | 29200 | 1.2 | 450 | 1.8 | 100.0% |

Table 1d

| | | | | TARGET + INTERACTIVE TOTAL | | | | | | |
|---|---|---|---|---|---|---|---|---|---|---|
| | | | | Example Metrics -- available today -- showing audience levels to the | | | | | | |
| Media | | | | | | | | Average | Average | Aud |
| Type | Network | Daypart | Target Media | Min (000) | Aud (000) | GI | GRP | Aud (000) | Aud | Share |
| Cable | TNT | Prime | Saving Grace | 210 | 2800 | 588000 | 23.5 | 1800 | 7.2 | 27.1% |
| | | Time | Charmed | 136 | 2900 | 394400 | 15.8 | 1650 | 6.6 | 24.8% |
| | | | The Closer | 294 | 4000 | 1176000 | 47.0 | 2200 | 8.8 | 33.1% |
| | | | Other | 199 | 1900 | 378100 | 15.1 | 1000 | 4.0 | 15.0% |
| Total | Total | | Total | 839 | 10000 | 2536500 | 101.5 | 6650 | 26.6 | 100.0% |

Table 1e

| | | | INTERACTIVE SCORES | | | | | | | | |
|---|---|---|---|---|---|---|---|---|---|---|---|
| | | | Example Metrics Based on Statistical | | | | Example Metrics Based on Simple Ratios | | | | |
| | | | | | | Incremental | Incremental | | | | |
| Media | | | | | | Interactive | Interactive | Min | Min | Aud | Aud |
| Type | Network | Daypart | Target Media | Coefficient | Index | Minutes | Aud | Factor | Index | Factor | Index |
| Cable | TNT | Prime | Saving Grace | 1.30 | 260 | 8 | 800 | 1.05 | 97 | 133.35 | 270 |
| | | Time | Charmed | 1.80 | 360 | 12 | 180 | 1.13 | 105 | 30.69 | 62 |
| | | | The Closer | .90 | 180 | 20 | 520 | 1.09 | 101 | 68.50 | 139 |
| | | | Other | 0.45 | 90 | 10 | 180 | 1.08 | 99 | 84.33 | 171 |
| Total | Total | | Total | 0.50 | 100 | 50 | 1200 | 1.08 | 100 | 49.39 | 100 |

TABLE 2

| | | | | | TARGET | | INTERACTIVE | | | | | | |
|---|---|---|---|---|---|---|---|---|---|---|---|---|---|
| | | | | | MEDIA | | MEDIA | | INTERACTIVITY SCORE | | | | |
| Media | Net- | Day- | Target | | Min | Aud | Min | Aud | Coef- | Min | Min | Aud | Aud |
| Type | work | part | Media | | (000) | (000) | (000) | (000) | ficient | Factor | Index | Factor | Index |
| Cable | TNT | Prime | Saving | Target Media | 200 | 2300 | 100 | 9000 | 3.08 | 1.50 | 143 | 4.91 | 415 |

| | | | | | | | | | |
|---|---|---|---|---|---|---|---|---|---|
| Time | Grace | Target Media Internet | 41 | 1000 | 4.20 | 1.21 | 115 | 1.43 | 121 |
| | | Saving Grace online episode | 15 | 780 | | | | | |
| | | TNT.com | 10 | 200 | | | | | |
| | | savingrace.com | 21 | 500 | | | | | |

| | | | | | | | |
|---|---|---|---|---|---|---|---|
| Sponsor Internet | 21 | 400 | 1.50 | 1.11 | 105 | 1.17 | 99 |

| | | |
|---|---|---|
| DoveHair.com | 8 | 200 |
| Real Beauty online video | 12 | 400 |
| Crest.com | 4 | 270 |

| | | | | | | | | | | | | |
|---|---|---|---|---|---|---|---|---|---|---|---|---|
| | | Charmed | Target Media | 120 | 1900 | 16 | 190 | 0.90 | 1.13 | 108 | 1.10 | 93 |
| | | The Closer | Target Media | 270 | 3200 | 24 | 540 | 0.75 | 1.09 | 103 | 1.17 | 99 |
| | | Bones | Target Media | 185 | 1700 | 14 | 300 | 0.02 | 1.08 | 102 | 1.18 | 99 |
| Total | Total | Total | Total | 210000 | 245000 | 11000 | 44800 | 1.00 | 1.05 | 100 | 1.18 | 100 |

TABLE 3
TABLE 3A

| | | | | | | TARGET MEDIA | | | INTERACTIVE MEDIA | | |
|---|---|---|---|---|---|---|---|---|---|---|---|
| | | | | | | | | Gross | | | Gross |
| Media | | Target | Interactive | Interactive | Interactive | Min | Aud | IMP | Min | Aud | IMP |
| Type | Daypart | Media | Media 1 | Media 2 | Media 3 | (000) | (000) | (000) | (000) | (000) | (000) |

| | | | | | | |
|---|---|---|---|---|---|---|
| Radio | Morning | WRKX-FM | Target | TV | NOT | Target Media Exposure |
| | Drive | | Media | Sponsor | SHOWN | Target Media Internet |

| Internet | | | Saving Grace |
|---|---|---|---|
| | | | American Idol |
| | Advertiser | | DoveHair.com |
| | Sponsor | | Crest.com |
| | | | Toyota.com |
| | Film | | Cable Guy |
| | (cinema) | | CableGuymovie.com |
| | Sponsor | | CableGuy Preview |
| TV | Target | TV Sponsor | |
| Sponsor | media | | Rockon.com |
| | Internet | | WRKX-FM.com |
| | Advertiser | | Clearchannel.com |
| | Sponsor | | DoveHair.com |
| | | | Crest.com |
| | | | Toyota.com |
| | Film | | Cable Guy |
| | (cinema) | | CableGuymovie.com |
| | Sponsor | | CableGuy Preview |
| Advertiser | TV | Advertiser Sponsor Internet Exposure | |
| Sponsor | Sponsor | | Saving Grace |
| | | | American Idol |
| | Film | | Cable Guy |
| | (cinema) | | CableGuymovie.com |
| | Sponsor | | CableGuy Preview |
| | Target | | Rockon.com |
| | media | | WRKX-FM.com |
| | Internet | | Clearchannel.com |
| Film | TV | Film (cinema) Sponsor | |
| (cinema) | Sponsor | | Saving Grace |
| Sponsor | | | American Idol |
| | Advertiser | | DoveHair.com |
| | Sponsor | | Crest.com |
| | | | Toyota.com |
| | Target | | Rockon.com |
| | media | | WRKX-FM.com |
| | Internet | | Clearchannel.com |

| | | | | | | | | |
|---|---|---|---|---|---|---|---|---|
| | WPDQ-FM | Target Media Exposure | 120 | 1900 | 228000 | 16 | 190 | 3040 |
| | WWBC-FM | Target Media Exposure | 270 | 3200 | 864000 | 24 | 540 | 12960 |
| | WLMR-AM | Target Media Exposure | 185 | 1700 | 314500 | 14 | 300 | 4200 |
| Total | Total | Target Media Exposure | 210000 | 245000 | ######## | 11000 | 44800 | ######## |

TABLE 3B

| | | | | | | INTERACTION | | | | | | | |
|---|---|---|---|---|---|---|---|---|---|---|---|---|---|
| Media | | Target | Interactive | Interactive | Interactive | Coef- | Incremental | Min | Min | Aud | Aud | Gross | Gross |
| Type | Daypart | Media | Media 1 | Media 2 | Media 3 | ficient | Exposure | Factor | Index | Factor | Index | Factor | Index |

| | | | | | | |
|---|---|---|---|---|---|---|
| Radio | Morning | WRKX-FM | Target | TV | NOT | Target Media Exposure |
| | Drive | | Media | Sponsor | SHOWN | Target Media Internet |

| Internet | | | Saving Grace |
|---|---|---|---|
| | | | American Idol |
| | Advertiser | | DoveHair.com |
| | Sponsor | | Crest.com |
| | | | Toyota.com |
| | Film | | Cable Guy |
| | (cinema) | | CableGuymovie.com |
| | Sponsor | | CableGuy Preview |
| TV | Target | TV Sponsor | |
| Sponsor | media | | Rockon.com |
| | Internet | | WRKX-FM.com |
| | Advertiser | | Clearchannel.com |
| | Sponsor | | DoveHair.com |
| | | | Crest.com |
| | | | Toyota.com |
| | Film | | Cable Guy |
| | (cinema) | | CableGuymovie.com |
| | sponsor | | CableGuy Preview |
| Advertiser | TV | Advertiser Sponsor Internet Exposure | |
| Sponsor | Sponsor | | Saving Grace |
| | | | American Idol |
| | Film | | Cable Guy |
| | (cinema) | | CableGuymovie.com |
| | Sponsor | | CableGuy Preview |
| | Target | | Rockon.com |
| | media | | WRKX-FM.com |
| | Internet | | Clearchannel.com |
| Film | TV | Film (cinema) Sponsor | |
| (cinema) | Sponsor | | Saving Grace |
| Sponsor | | | American Idol |
| | Advertiser | | DoveHair.com |
| | Sponsor | | Crest.com |
| | | | Toyota.com |
| | Target | | Rockon.com |
| | media | | WRKX-FM.com |
| | Internet | | Clearchannel.com |

| | | | | | | | | |
|---|---|---|---|---|---|---|---|---|
| | WPDQ-FM | Target Media Exposure | 1.13 | 108 | 1.10 | 93 | 1.01 | 100 |
| | WWBC-FM | Target Media Exposure | 1.09 | 103 | 1.17 | 99 | 1.02 | 101 |
| | WLMR-AM | Target Media Exposure | 1.08 | 102 | 1.18 | 99 | 1.01 | 100 |
| Total | Total | Target Media Exposure | 1.05 | 100 | 1.18 | 100 | 1.01 | 100 |

TABLE 4
Table 4a

| | | | TARGET MEDIA | | | INTERACTIVE MEDIA | | |
|---|---|---|---|---|---|---|---|---|
| | | | | | Gross | | | Gross |
| Media | | | Min | Aud | IMP | Min | Aud | IMP |
| Type | Daypart | Target Media | (000) | (000) | (000) | (000) | (000) | (000) |

| | | | | | | | | | |
|---|---|---|---|---|---|---|---|---|---|
| Radio | Morning | WRKX-FM | Target Media Exposure | 200 | 2300 | 460000 | 3000 | 25000 | 75000000 |
| | Drive | | Target Media Internet Exposure | | | | 45 | 800 | 36000 |

| | | | |
|---|---|---|---|
| WRKX-FM.com | 21 | 500 | 10500 |
| Rockon.com | 10 | 200 | 2000 |

| | | | |
|---|---|---|---|
| Sponsor TV Exposure | 2000 | 23000 | 46000000 |

| | | | |
|---|---|---|---|
| American Idol | 900 | 9000 | 8100000 |

| | | | |
|---|---|---|---|
| Sponsor Internet Exposure | 41 | 1000 | 41000 |

| | | | |
|---|---|---|---|
| AmericanIdol.com | 21 | 400 | 8400 |
| Toyotatrucks.com | 10 | 200 | 2000 |
| DoveHair.com | 8 | 200 | 1600 |
| Crest.com | 4 | 270 | 1080 |

| | | | | | | | | |
|---|---|---|---|---|---|---|---|---|
| | WPDQ-FM | Target Media Exposure | 120 | 1900 | 228000 | 16 | 190 | 3040 |
| | WWBC-FM | Target Media Exposure | 270 | 3200 | 864000 | 24 | 540 | 12960 |
| | WLMR-AM | Target Media Exposure | 185 | 1700 | 314500 | 14 | 300 | 4200 |
| Total | Total | Target Media Exposure | 210000 | 245000 | 51450000000 | 11000 | 44800 | 492800000 |

Table 4b

| | | | INTERACTION | | | | | |
|---|---|---|---|---|---|---|---|---|
| Media | | | Min | Min | Aud | Aud | Gross | Gross |
| Type | Daypart | Target Media | Factor | Index | Factor | Index | Factor | Index |

| | | | | | | | | | |
|---|---|---|---|---|---|---|---|---|---|
| Radio | Morning | WRKX-FM | Target Media Exposure | 1.11 | 105 | 1.22 | 103 | 1.02 | 101 |
| | Drive | | Target Media Internet Exposure | 1.05 | 100 | 1.09 | 92 | 1.00 | 99 |

WRKX-FM.com
Rockon.com

| | | | | | | |
|---|---|---|---|---|---|---|
| Sponsor TV Exposure | 1.21 | 115 | 1.43 | 121 | 1.09 | 108 |

American Idol

| | | | | | | |
|---|---|---|---|---|---|---|
| Sponsor Internet Exposure | 1.11 | 105 | 1.22 | 103 | 1.02 | 101 |

AmericanIdol.com
Toyotatrucks.com
DoveHair.com
Crest.com

| | | | | | | | | |
|---|---|---|---|---|---|---|---|---|
| | WPDQ-FM | Target Media Exposure | 1.13 | 108 | 1.10 | 93 | 1.01 | 100 |
| | WWBC-FM | Target Media Exposure | 1.09 | 103 | 1.17 | 99 | 1.02 | 101 |
| | WLMR-AM | Target Media Exposure | 1.08 | 102 | 1.18 | 99 | 1.01 | 100 |
| Total | Total | Target Media Exposure | 1.05 | 100 | 1.18 | 100 | 1.01 | 100 |

The various rows in Tables 14 represent summary level data (i.e., comprising all interactive media use related to the respective programs). A user would be able to “click” to see more rows (sub-rows) that contain actual websites, webisode names, commercials, and the like, for the media's own sites/commercials/promos and their sponsors (the advertisers), sites/commercials/online video, and the like, as shown, for example, in Table 3.

The Interactivity Scores can be simple ratios but they can also be the outcome of statistical models. Statistical models may be used to determine causality and to show incremental increases in exposure; that is, exposure over the level that would be expected to happen anyway, among other things. Statistical models may use time series data and find whether they are related. The “time series” in this example would be instances of exposure to the program and instances of interactivity, which are “time series” because they are captured continuously from panelists over time. These data would be statistically related to one another to determine causality, e.g., did program exposure “cause” the interactivity, or were they random events? So if one is studying exposure to radio and the level of “American Idol” viewing that radio generated, one would want to know the incremental increase in exposure—i.e., that which can be attributed to the radio programming or the radio advertising campaign. Statistical models used could include ANCOVA, regression analysis, CHAID or any number of techniques that are well-known in the art. The Coefficient column reports the result of a regression analysis to estimate interactivity. The Incremental Interactive Audience uses the Coefficient to estimate the incremental audience to the interactive media that is generated by the target media. “Incremental” refers to the audience level beyond that which would occur organically/naturally. “Example Metrics based on Simple Ratios” are just that—the “min factor” divides the interactive minutes by total minutes. The index divides the min factor for the respective program by the TOTAL min factor.

Referring to Table 1, including Tables 1a, 1b, 1c, 1d, and 1e, the report shows data relating to cable television, and in particular, data related to certain target television programs that have been shown on the TNT network during “prime time” (i.e., evenings between 8:00 pm and 11:00 pm Eastern Time). Thus, these programs act as a first medium. The second medium in Table 1 is represented by the same set of programs. In this example, Total is for the total daypart (i.e., prime time) for cable programs. It could be the total day for all programs. Note that in Table 1d, Min (000) is the sum of minutes to Target and Interactive Media, and Aud (000) will be for a larger audience—because for these reports, one is investigating the interactive exposure that is “caused” by the target media exposure. The other metrics, GI, GRP, Average Aud (000), Average Aud, and Aud Share are defined and used in a similar manner as discussed above.

The data would also include total exposure to the interactive media itself, as also shown in Table 1. Some of the metrics are not straight sums because there is duplication of audience between Target & Interactive. It is noted that there are metrics not shown here that apply to Internet, including “page views” and “unique users”. It is further noted that there are metrics not shown here that apply to radio, Including Average Quarter Hour (AQH). In short, additional metrics may be incorporated.

Referring to Table 2, the report shows data relating to cable television, and in particular, data related to certain target television programs that have been shown on the TNT network during “prime time” (i.e., evenings between 8:00 pm and 11:00 pm Eastern Time). Thus, these programs act as a first medium. The second medium in Table 2 is represented by certain particular web sites that are associated with the particular program. Web sites associated with a given program may include, for example, a program web site, a network web site, a web site relating to the talent associated with the program, or a web site or web content relating to an advertiser that is a sponsor of the program. For the second medium, the tallied numbers are compiled on the basis of a predetermined time limit from the broadcast of the target program. For example, the tallied data may indicate a number of persons that accessed the web site within two weeks of the broadcast of the program. Alternatively, the tallied data may be based on a number of persons that accessed the web site during the program broadcast, or within two hours of the program broadcast, or any desired time interval relative to the program broadcast.

A report may contain tallies of total audience to either medium, using metrics such as, for example, average minute audience, cumulative audience, reach, and number of minutes. A report may contain tallies of audience to the interaction medium (i.e., the second medium) that were also exposed to the target medium (i.e., the duplicated audience), as well as tallies relating to the unduplicated audience. Reports may contain metrics that compare interactivity at a total population level to interactivity for specific target media.

The metrics may embody any of the weights, datasets and converted datasets described above, and may be formed into rules tailored to meet a specific qualitative and/or quantitative need. For example, person-level data may be obtained for representing household-level media exposure, media usage and/or consumer behavior as described above. Data from multiple sources, perhaps provided in different formats, timeframes, etc., may be combined to produce various data describing the conduct of a study participant or panelist as a single source of data reflecting multiple purchase and/or media usage activities. An assessment of the links between exposure to advertising, and the shopping habits of consumers may be carried out. Data about panelists may then be gathered to correlate information pertaining to, for example, panelist demographics, exposure to various media including television, radio, outdoor advertising, newspapers and magazines, retail store visits, purchases; Internet usage, and consumers beliefs and opinions relating to consumer products and services.

Referring to Table 4, an additional example report shows data relating to radio, and in particular, selected radio stations during the “morning drive” portion of the day (i.e., between 6:00 am and 9:30 am on weekdays). The interactive media in the exemplary report include several web sites associated with the radio station, several web sites associated with sponsor that air advertisements on the radio station during morning drive, and a television program that is associated with the radio station's morning drive broadcast.

In an alternative embodiment of the invention, a person may be exposed to a sequence of several media. In one exemplary aspect, this embodiment includes a final medium by which the person actually purchases a product that was the subject of at least one advertisement during one of the exposures of the several media. The present invention provides a metric to indicate a measure of a degree to which a particular sequence of media exposures leads to additional activity by the consumer. This type of metric is especially useful to potential advertisers. Referring to Table 3, an additional example report illustrates interaction among at least three separate media, labeled as “Target Media”, “Interactive Media 1”, “Interactive Media 2” and Interactive Media 3”.

For example, a person may receive an e-mail while at work. The e-mail may include some information that prompts the person to view a particular web site. Upon accessing the web site, the person sees an advertisement for a particular product. Then, while driving home, the person may also hear an advertisement for that product while listening to the radio; or, the person may see a billboard that contains an advertisement for the product. Finally, after these multiple exposures, the person executes the act of going to the store to purchase the advertised product, or the person accesses the Internet to purchase the product online. In this scenario, the metric for this sequence would be calculated to show a very high correlation between the several media.

Although various embodiments have been described with reference to a particular arrangement of parts, features and the like, these are not intended to exhaust all possible arrangements or features, and indeed many other embodiments, modifica-tions and variations will be ascertainable to those of skill in the art.

What is claimed is:

1. A method for measuring audience interactivity between at least a first medium and a second medium, each person in a first audience having been exposed to the first medium and each person in a second audience having been exposed to the second medium, the method being executed by using at least one electronic device, and the method comprising the steps of:
obtaining first data relating to an exposure of the first medium to each person belonging to the first audience;
obtaining second data relating to an exposure of the second medium to each person belonging to the second audience;
using the first data and the second data to determine an overlap audience based on whether each person belonging to the first audience also belongs to the second audience;
correlating the first data with the second data with respect to each person belonging to the overlap audience; and
calculating a metric based on a result of the correlating step.

2. The method of claim 1, wherein, for each person of the first and second audiences, each of the first data and the second data includes a time at which the respective exposure occurred, and the step of correlating further comprises determining an interval between the exposure of the first medium and the exposure of the second medium with respect to each person belonging to the overlap audience.

3. The method of claim 1, wherein the first medium comprises one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium, and
wherein the second medium comprises one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium.

4. The method of claim 1, wherein the metric comprises a dimensionless numerical coefficient having a magnitude that is correlated with audience interactivity between the first medium and the second medium.

5. The method of claim 1, wherein the metric comprises a number of minutes that is correlated with audience interactivity between the first medium and the second medium.

6. A system for measuring audience interactivity between at least a first medium and a second medium, each person in a first audience having been exposed to the first medium and each person in a second audience having been exposed to the second medium, the system comprising at least one electronic device having a processor, and the processor being configured to:
receive first data relating to an exposure of the first medium to each person belonging to the first audience;
receive second data relating to an exposure of the second medium to each person belonging to the second audience;
use the first data and the second data to determine an overlap audience based on whether each person belonging to the first audience also belongs to the second audience;
correlate the first data with the second data with respect to each person belonging to the overlap audience; and
calculate a metric based on a result of the correlation.

7. The system of claim 6, wherein, for each person of the first and second audiences, each of the first data and the second data includes a time at which the respective exposure occurred, and the processor is further configured to determine an interval between the exposure of the first medium and the exposure of the second medium with respect to each person belonging to the overlap audience.

8. The system of claim 6, wherein the first medium comprises one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium, and
wherein the second medium comprises one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium.

9. The system of claim 6, wherein the metric comprises a dimensionless numerical coefficient having a magnitude that is correlated with audience interactivity between the first medium and the second medium.

10. The system of claim 6, wherein the metric comprises a number of minutes that is correlated with audience interactivity between the first medium and the second medium.

11. A computer-readable storage medium for storing instructions that are executable by a computer, the storage medium comprising a computer program for measuring audience interactivity between at least a first medium and a second medium, each person in a first audience having been exposed to the first medium and each person in a second audience having been exposed to the second medium, and the computer program including instructions for causing an electronic processor to:
receive first data relating to an exposure of the first medium to each person belonging to the first audience;
receive second data relating to an exposure of the second medium to each person belonging to the second audience;
use the first data and the second data to determine an overlap audience based on whether each person belonging to the first audience also belongs to the second audience;
correlate the first data with the second data with respect to each person belonging to the overlap audience; and
calculate a metric based on a result of the correlating step.

12. The storage medium of claim 11, wherein, for each person of the first and second audiences, each of the first data and the second data includes a time at which the respective exposure occurred, and the step of correlating further comprises determining an interval between the exposure of the first medium and the exposure of the second medium with respect to each person belonging to the overlap audience.

13. The storage medium of claim 11, wherein the first medium comprises one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium, and
wherein the second medium comprises one of a television program; a television channel; an on-demand television video; a digital video recording; a radio program; a radio station; an Internet web site; a genre of Internet web sites; a video accessed via the Internet; an audio accessed via the Internet; an advertisement accessed via the Internet; a newspaper; a magazine; a periodical publication; a book; a billboard; outdoor signage; a movie trailer; a product placement in a movie; an interactive shopping kiosk; a touch-screen mobile telephone; a personal digital assistant; eyeglasses with an interactive screen; a voice module; an e-mail transmission; a computer game; an on-line game; and advertising content provided by any such medium.

14. The storage medium of claim 1, wherein the metric comprises a dimensionless numerical coefficient having a magnitude that is correlated with audience interactivity between the first medium and the second medium.

15. The storage medium of claim 11, wherein the metric comprises a number of minutes that is correlated with audience interactivity between the first medium and the second medium.
